(19) United States
(12) Patent Application Publication
(10) Pub. No.: US 2007/0260932 A1
(43) Pub. Date: Nov. 8, 2007

(54) Event log management system

(76) Inventors: Ryan Prichard, Loveland, CO (US); Ben Rogel-Favila, Santa Clara, CA (US)

Correspondence Address: VERIGY, 4700 INNOVATION WAY, BLDG D1, FORT COLLINS, CO, 80528, US

(21) Appl. No.: 11/402,113

(22) Filed: Apr. 11, 2006

(51) Int. Cl. G06F 11/00

(52) U.S. Cl. 714/39

(57) ABSTRACT

The present invention is an event log management system and method for monitoring the reliability of test systems. An event log management system includes a data store which stores at least one tester configuration file, a hardware independent event capture function which captures events from at least one monitored tester associated with one of the at least one test configuration files, a graphical user interface which receives issue information from a user, and a server which manages storage and tracking of the captured events.

### BACKGROUND OF THE INVENTION

The present invention relates generally to test system reliability monitoring, and more particularly to systems and methods for application specific event log management.

Modern semiconductor manufacturing facilities utilize Automated Test Equipment (ATE) for testing integrated circuit devices. ATE allows automated testing of integrated circuits and is therefore of paramount importance for achieving reliable high volume manufacturing of such devices. ATE may be linked to a wafer prober to test semiconductor wafers prior to dicing and packaging into individual integrated circuit devices. ATE may also be linked to a device handler to test packaged devices. The combination of ATE with a wafer prober and/or device handler is often referred to as a test cell.

The test cell is the cornerstone in the implementation of a semiconductor manufacturer's test strategy for a manufacturing facility. During high volume integrated circuit manufacturing, the failure of a test cell can lead to loss of significant revenue if not addressed expediently. Of course, it is always preferable and more cost effective to actively prevent test cell failures prior to their occurrence rather than to diagnose and repair the test cell after a failure occurs.

Therefore, system reliability monitoring, prediction and improvement based on measured data acquired in the target test cell(s) is of great interest to semiconductor manufacturers.

One of the difficulties with monitoring reliability of a distributed fleet of test cells is the process of gathering the information. Currently, most acquisition of data relating to the reliability of a test cell is manual, taking the form of a technician observing the test cell behavior, recording specific results, and centralizing the data in a manner that can be easily summarized for a floor manager. This process is inefficient, and can lead to incomplete or error-prone data.

An improvement over the above technique is the use of software implemented to facilitate the gathering and reporting aspects of the process. While certainly an improvement over the manual process, it still suffers from potential data entry error by the technician. Oftentimes the test cell data can be esoteric and cumbersome to verify its correctness before being entered. Such examples are serial numbers and diagnostic measurements.

The monitoring of test cell reliability and the problems associated therewith applies generally to all test equipment, especially automated test equipment, or hereinafter simply “testers”, that are distributed in a high-volume manufacturing facility.

It would therefore be desirable to have a system that identifies, acquires, stores, analyzes, and reports fundamental test cell data that will enable the monitoring and improvement of the test cell reliability, thereby helping to maximize the time that the test cell is operating properly.

### SUMMARY OF THE INVENTION

Embodiments of the invention include methods and apparatus for monitoring tester reliability.

In one embodiment, an event log management system comprises a data store which stores at least one tester configuration file, a hardware independent event capture function which captures events from at least one monitored tester, each associated with a corresponding test configuration file, a graphical user interface which receives issue information from a user, and a server which receives the issue information from the graphical user interface and creates an issue data element corresponding to the issue information, and which receives the captured events from the event capture function and stores the captured events in an event store, associating respective captured events with corresponding respective issues.

In one embodiment, a method for managing events of at least one tester comprises obtaining at least one tester configuration file, automatically capturing events from at least one monitored tester associated with one of the at least one test configuration files using a hardware independent interface, receiving issue information, and providing a server which creates an issue data element corresponding to the issue information, and which stores the captured events in an event store, and associates respective captured events with corresponding respective issues.

In one embodiment, an Event Log Management System comprises a data store which stores at least one tester configuration file, each tester configuration file implemented in XML and comprising one or more event type definitions and corresponding attribute definitions, a hardware independent event capture function which captures events from at least one monitored tester associated with one of the at least one test configuration files, a Web enabled graphical user interface which receives issue information associated with a user perceived condition from a user, and a server which creates an issue file implemented in XML corresponding to and encapsulating the issue information, and which encapsulates captured events captured by the hardware independent event capture function in respective issue files corresponding to respective issues to which the respective captured events are associated.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram illustrating networked use of an Event Log Management System;

FIG. 2 is a block diagram illustrating an exemplary embodiment of an Event Log Management System;

FIG. 3 is a diagram of an event;

FIG. 4 is a diagram of an issue;

FIG. 5 is a perspective view of a tester that may be monitored by the Event Log Management System;

FIG. 6 is a functional block diagram illustrating the functional logic of an exemplary embodiment of event log management software;

FIG. 7 is a functional block diagram illustrating the functional logic operation of an exemplary embodiment of a Web GUI;

FIG. 8 is a screen shot of an exemplary embodiment of an event summary report presented by the Web GUI of the Event Log Management System; and

FIG. 9 is a screen shot of an exemplary embodiment of an event detail report presented by the Web GUI of the Event Log Management System.

### DETAILED DESCRIPTION

In the following detailed description of the embodiments, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural logical and electrical changes may be made without departing from the spirit and scope of the present inventions. The following detailed description is, therefore, not to be taken in a limiting sense, and the scope of the present inventions is defined only by the appended claims.

Embodiments of the invention presented herein describe systems and methods to identify, acquire, store, analyze, and report fundamental test cell data that enables the monitoring and improvement of the tester reliability, thereby helping to maximize the time the test cell is up and running normally.

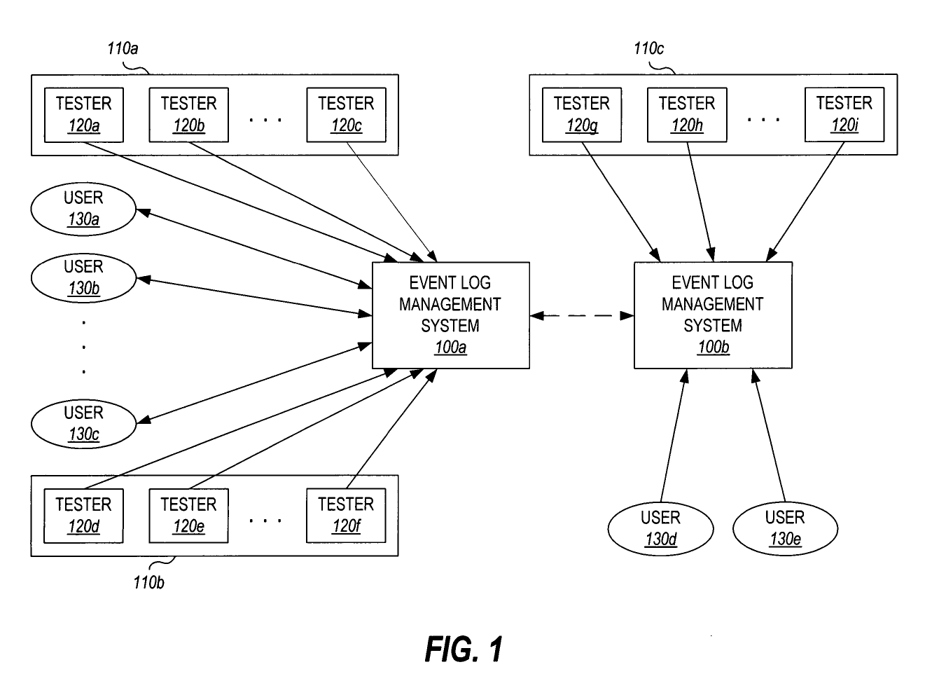

FIG. 1 is a block diagram illustrating the use of an Event Log Management System 100a monitoring a number of testers 120a, 120b, 120c, 120d, 120e, 120f. Testers 120a, 120b, 120c are located at site 110a, while testers 120d, 120e, 120f are located at site 110b. A number of users 130a, 130b, 130c may connect to the Event Log Management System 100a via a web browser to interact with the system 100a.

A site may be physical or logical. For example, a site may be a physical geographical location, and/or a site may be a logical distributed fleet of testers under common business control. One or more additional Event Log Management Systems 100b may monitor another number of testers 120g, 120h, 120i, which may or may not be located at a number of different respective sites 110c. A number of users 130d, 130e may connect to the Event Log Management System 100b via a web browser to interact with the system 100b.

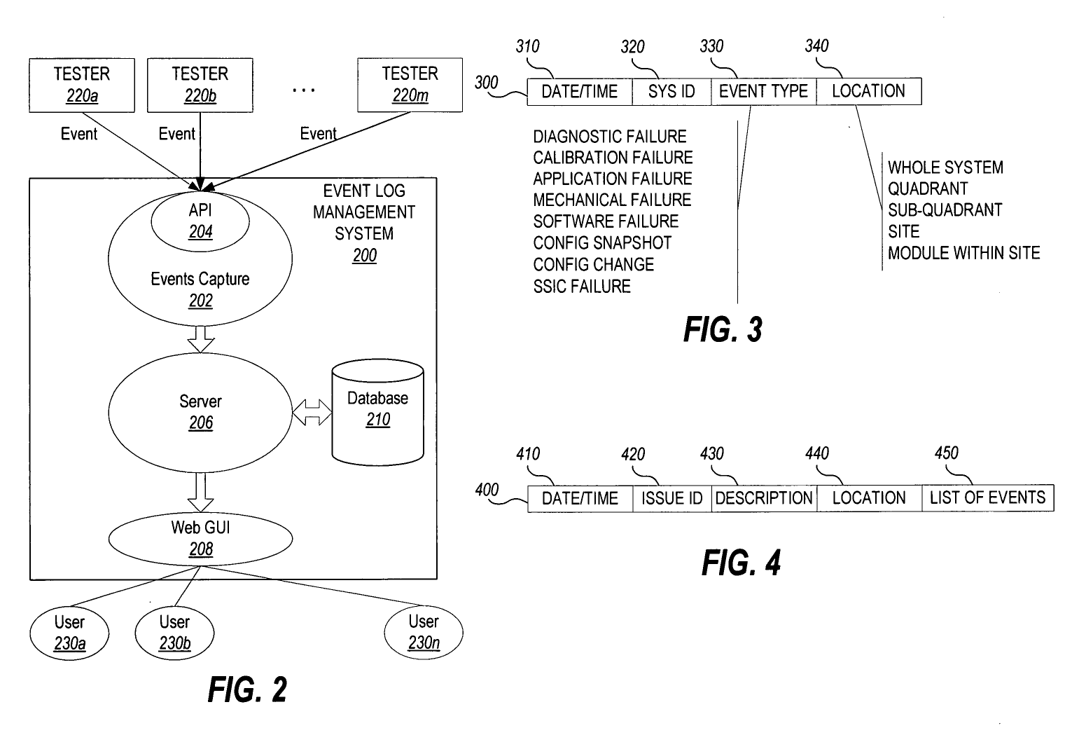

FIG. 2 is a block diagram illustrating an exemplary embodiment of an Event Log Management System 200 that may implement the Event Log Management System(s) 100a, 100b of FIG. 1. As illustrated, the system 200 includes an Event Capture module 202, an Application Program Interface (API) module 204, a Server module 206, a Web GUI module 208, and an event store 210. One or more testers 220a, 220b, 200m are monitored by the system 200. The testers 220a, 220b, 200m generate events that reflect the operating state of one or more components of the respective testers 220a, 220b, 200m. The Event Log Management System 200 captures, indexes, and stored the captured events in the event store 210. Users 230a, 230b, 230n may request various reports relating to the stored events and may enter event data manually.

An event is a specific occurrence of an operating state of a given tester as defined in a tester configuration file corresponding to the tester. Events may be captured automatically through the use of the event capture module 202. Events may also be entered into the system manually by a user through the Web GUI 208.

FIG. 3 illustrates an exemplary test system event 300 diagrammatically. In this embodiment, each test system event 300 comprises a date and time stamp 310, a system ID 320 (for example, a hostname), an event type 330, and a location 340. An event may include additional attributes (not shown) depending on the value of the event type.

The possible event types and corresponding attributes may vary from application to application, and are configurable by way of a tester configuration file, which in an exemplary embodiment is implemented as an XML file. For example, in an exemplary embodiment, the event type 230 of a given event may be one the following types:

Diagnostic failure: A diagnostic test failed. Diagnostic information ssuch as the test number, description,
test value and limit information may be provided in event attribute fields
Calibration failure: A calibration (for example, a Programmable Power Supply (PPS), Pin Electronics (direct
current) (PE DC), Pin Electronics (alternating current) (PE AC), Algorithm Pattern Generator (APG) etc.) failed
on the given piece of hardware
Application Failure: An application (for example, a customer's software to run a particular test) failed on
the given piece of hardware
Machanical Failure: A piece of hardware failed.

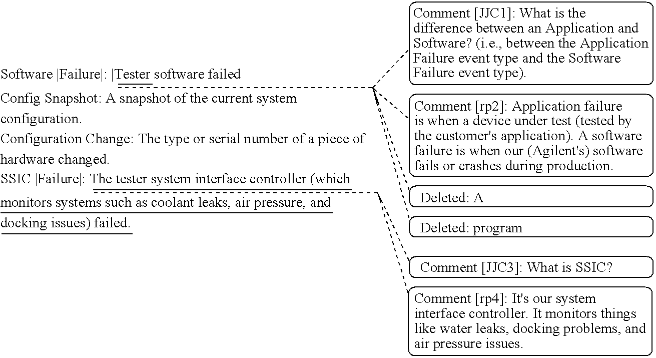

In an exemplary embodiment, the event location 240 may be one of likewaterleaks dockingproblems,and the following:
the whole system
a system quadrant
a sub-quadrant
a site
a module within a site 0c

For example, referring to FIG. 1, a site 110a, 110b, 110c (perhaps corresponding to a particular geographical location) is a set of systems. A system might be a particular tester 120a, . . . , 120i, such as a test cell. A system may comprise a plurality of modules such as PPS, PE, APG, etc. A module may comprise several sub-modules (for example, four quadrants in the PE module). Sub-modules may be further sectioned (for example, into sub-quadrants).

Issues are a higher level abstraction of one or more events. Essentially, an issue describes what the actual problem was, rather than its collective symptoms (which are the events). In other words, issues encapsulate events. As an example, suppose a given tester generates a diagnostic failure event, a configuration change event (from swapping boards to see if the failure will follow the board), and then another diagnostic failure. These events may all relate to the same issue, which may be, for example, that the site module is defective and needs to be replaced. Thus, the issue is what the technician sees and works with, while the events are the low level detail that the vendor is concerned with. Issues may be entered into the system manually by a user through the Web GUI 208.

FIG. 4 illustrates an exemplary issue 400 diagrammatically. In this embodiment, an issue 400 comprises one or more attributes such as a date/time 410, an issue ID 420, an issue description 430, an issue location 440, and a list 450 (or pointers to) one or more events associated with the issue.

Server Module

The Server 206 manages the event store 210, which is a central storage location for storing details of events and issues.

The Server 206 aggregates the information from all tester and user clients that have been configured to use the Server 206. In one embodiment, a single Server 206 services all clients in operation. In another embodiment, multiple Servers 206 service subsets of the clients. For example, one Server 206 may service clients in one or more geographical locations, while another separate Server 206 may service clients in another geographical location. For example, system 100a in FIG. 1 serves testers at sites 110a and 110b, while system 100b serves testers at site 110c. If multiple Servers 206 are used by a customer, in one embodiment, data may be exported and imported from one Server 206 to another, thereby allowing data to be aggregated into one logical Server 206 for analysis. Thus, using the above example, event and issue data may be exported from system 100b to system 100a, or vice versa.

The Server 206 also implements the functional logic that provides the user with web access to provide detailed information on new events and issues, and to edit and analyze existing issues.

Event Identification and Capture

The process of testing ICs using a tester such as an ATE test cell generates large amounts of data. Some of this data relates to the characteristics of the ICs themselves. Other parts of this data relates to the interactions between the ICs and the test cell, while another part of this data relates to the states and general operating conditions of the test cell.

The states through which the test cell transitions depend largely on the particular programmed sequence set up by the user. Test cell reliability depends to some extent on this test sequence. For example, some test sequences may stress the test cell more than other test sequences, leading to potentially more failures over time.

The Event Capture module 202 automatically adapts to any programmed test sequence and automatically captures events from monitored testers which reflect the state and operating conditions of the monitored testers at any selected time. The Event Capture module 202 comprises software code configured to receive events from monitored test devices. Events from each monitored test device may be configured differently, and is defined in a tester configuration file associated with the tester that generates the event. The Event Capture module 202 communicates with each monitored tester using a published API (as implemented in the API module 204).

API Module

The API module implements an Application Program Interface that allows an application or software component (e.g., ATE system software, a software tool or even a customer application utilizing the Event Log Management System 200) to log an event with detailed information to the Server 206.

The Event Log Management System utilizes a published API which defines a clear interface with which testers need to adhere to in order to store its data effectively. The advantage of publishing the API to the customers is that if a customer wishes to extend the Event Log Management System 200 to capture events and track issues for other types of devices (such as handlers, ovens, or other testers), the manufacturer of a specific device need only publish its own Event Log Management System configuration file (describing different event types and their attributes) and ensure its software adheres to the API.

In an exemplary embodiment, the Event Log Management System utilizes “Web Services”, a well-known universal standard that supports interoperable machine-to-machine interaction over a network. In one embodiment, Web Services Description Language (WSDL) is used in combination with Simple Object Access Protocol (SOAP) and Extensible Markup Language (XML) Schema to provide web services over the internet. WSDL describes the public interface to the web service. WSDL is an XML-based service description on how to communicate using the web service; namely, the protocol bindings and message formats required to interact with the web services listed in its directory. The supported operations and messages are described abstractly, and then bound to a concrete network protocol and message format. SOAP is a protocol for exchanging XML-based messages over a computer network, normally using HyperText Transfer Protocol (HTTP) to transfer or convey information on the World Wide Web. Web Services, WSDL, XML, and SOAP are well-known in the art and are described in detail at http://en.wikipedia.org/wiki/Web_services.

The API 204 also provides a mechanism for feedback that triggers the Web GUI 208 for an event so that the user can provide additional information for an event (e.g., to allow the technician to enter notes to the event).

The API 204 may also transparently provides a fail-back mechanism in case a Server 206 is not available (for example, due to network problems) that provides essential tracking capabilities offline. To this end, if the server 206 is unavailable, an event generating tester 220 will cache each generated event to its local data store (such as a local hard drive). Each time an event is generated, the tester first attempts to purge all “cached” events to the server 206. If the Server 206 is available, the cached events are purged to the Server 206 and the cache is emptied. If the Server 206 is unavailable, the tester 220 will continue caching events.

Web GUI

The Web GUI 208 implements a graphical user interface that allows a user to interact with the event log management system. In a preferred embodiment, the Web GUI 208 is Web-enabled to allow a user to access the system 200 using only a Web browser and a network connection. The GUI functionality is stored on the Server 206 itself, thereby eliminating the need for special software at the user clients 230a, . . . , 230n.

The Web GUI 208 serves the two main purposes of issue/event input and issue/event reporting.

In terms of issue/event input, the Web GUI 208 allows the user to specify (and also, to an extent, modify) additional data for issues and events that are logged to the Server 206. For example, issues are set up and entered through the GUI 208. In addition, an event often includes a Notes attribute that allows the user to enter additional notes associated with the event. Additionally, the server 206 may trigger the Web GUI 208 when it receives a new event from a monitored tester to allow the user to provide additional information on an event or assign it to an issue.

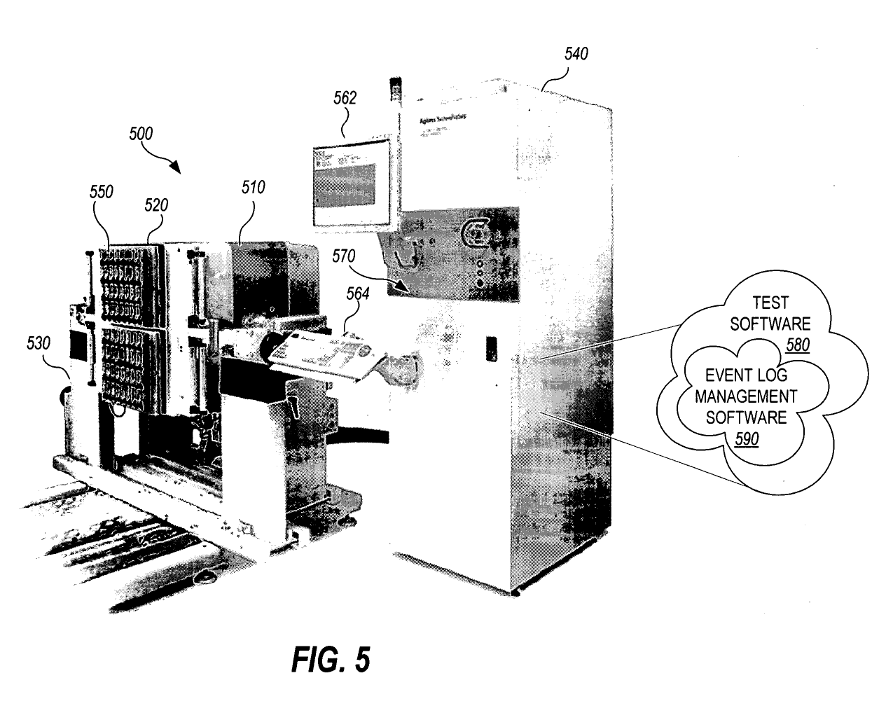

FIG. 5 illustrates an exemplary embodiment of a tester 500, specifically an Agilent Versatest V5500 (manufactured by Agilent Technologies, Inc. of Palo Alto, Calif.), that may be monitored by the Event Log Management System 200 of FIG. 2. As illustrated, the Versatest V5500 500 comprises test head 510 with DUT (Device under test) interface 520, a manipulator 530 for positioning test head 510, DUT board 550 which plugs into underlying DUT interface 520, support rack 540 for supplying test head 510 with electrical power, cooling water and compressed air (not shown in the Figures).

Test head 510 comprises tester electronics including pin electronics (PE), programmable power supplies (PPS), algorithmic pattern generators (APG) and additional analog modules. Test head 510 is configured with a number of pins, for example 4096 pins. The test head supports 36 card cages. Each card cage can contain 9 digital boards or 9 analog modules, respectively. The DUT is mounted on DUT board 550, which is connected to the I/O channels by DUT interface 520. DUT interface 520 consists of high performance coax cabling and spring contact pins (pogo pins) which establish electrical connection with DUT board 520.

General-purpose manipulator 530 supports and positions test head 510, providing precise and repeatable connections between test head 500 and handlers or wafer probers.

Support rack 540 is attached to manipulator 530 and serves as the interface between test head 510 and AC power, cooling, and compressed air.

The tester 500 may include a display 562, a keyboard 564, and a mouse (not shown), which may serve as the interface between the user and tester 500. Other input and output devices (not shown) may also be communicatively connected to the tester 500.

Test software may execute on a computer or workstation 570 to allow a user to configure and set up tests, and observe test status and test data

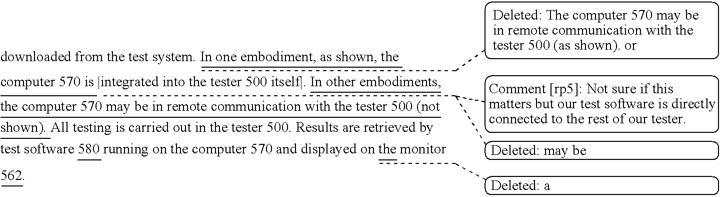

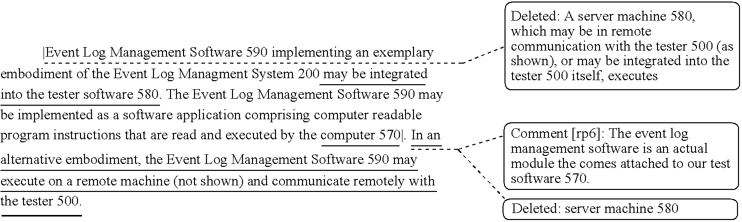

The Web GUI of the Event Logging and Reporting Software 590 displays Web pages on a user's display 562 and receives user input via the Web interface.

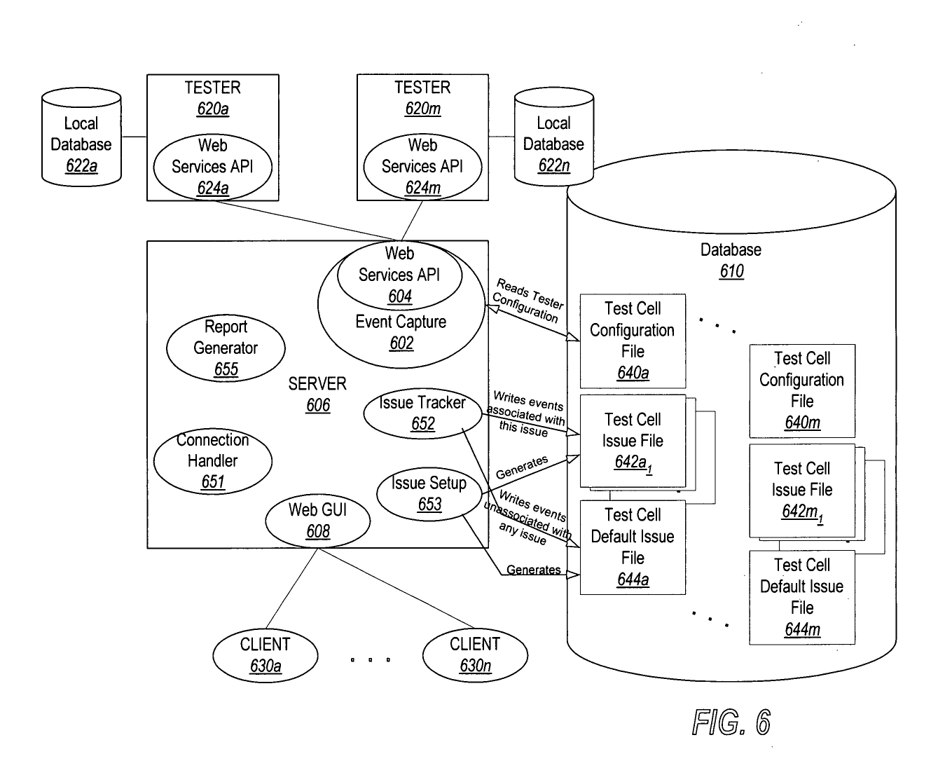

FIG. 6 is a functional block diagram illustrating the functional logic of an exemplary embodiment 600 of the event log management software 590. The software 600 includes an Event Capture module 602, an Application Program Interface (API) module 604, a Server module 606, a Web GUI module 608, and an event store 610.

The Server 606 includes a connection handler function 651 which establishes connections and maintains the connections between the Event Log Management System 600 and the monitored testers 620a, 620b, 620m.

Test cells that are monitored by the system 600 each have a corresponding test configuration file. Thus, for example, if the test cell 500 of FIG. 5 corresponds to tester 620a in FIG. 6, the tester 620a has a corresponding tester configuration file 640a stored in the event store 610 of FIG. 6. Each tester configuration file 640a, . . . , 640m is specific to its corresponding tester 620a, . . . , 620m. In a preferred embodiment, the tester configuration files 640a, . . . , 640m are implemented as XML files, storing XML data comprising three categories of information pertaining to a given test cell:
List of event types. Each test cell is capable of generating different types of events. Each event has its own properties and attributes. Many properties and attributes are unique to that particular type of event, which requires the Event Log Management System to distinguish between different event types.
List of attributes (for a particular event type). Since each event may have unique attributes or properties, the description of these attributes and properties are described. For example, the attribute name for a particular event type and the possible values for the attribute are listed.
Graphical representation information (for each attribute). The test cell configuration file contains graphical user interface (GUI) information that assists the presentation layer in displaying event information to the end user. For each event attribute, a configuration file specifies input field type and input field length. The input field type may be, for example, a text file, a text area, a combo box, a radio control, etc. The input field length will correspond to the input field type. For example, the input field length corresponding to an input field type comprising a text file may be the size of the text field. Similarly, the input field length corresponding to an input field type comprising a text area may be the dimensions of the text area.

The tester configuration files 640a, . . . , 640m are stored directly within the system's own database (i.e., the event store 610).

Below is an exemplary XML file of an example configuration file associated with the Agilent Versatest V5500 system of FIG. 5.

A key to the TestCell.xml file describing the contents is shown in TABLE 1.

TABLE 1

| Element | Type | Description |
|---|---|---|
| Event | Name | Name of type of event. |
| textField | Name | Name of text attribute |
| comboBox | Name | Name of comboBox attribute |
| option | value | Option associated with a comboBox |
| textArea | Name | Graphical dimensions for displaying |
| | | text |

The logic implementing the Web GUI 608 runs on the Server 606 and not on the client(s). Therefore, the end user needs only to have access to a web browser to access the Event Log Management System 600. By centralizing the GUI on the server, version control of the GUI is simple and universal, requiring version update only on the server and not at the individual user clients 630a, 630b, 630n. The clients 630a, 630b, 630n need no special software to access the system 600.

The Server 606 assigns each captured event to a specific issue which belongs to the same tester client. Thus, if a tester 620a generates an event, the event may only be assigned to an issue that is associated with (i.e., belongs to) tester 620a. The Server 606 copies all information on an issue to an XML file stored in the Server database 610 whenever the issue is updated. This allows the user to process the information on an issue with another application.

The Server 606 may be configured to track multiple issues per client. In one embodiment, issues associated with a given tester client 620a, 620b, 620m are stored in one or more corresponding XML file(s) 640a₁, . . . , 640aᵢ, 640b₁, . . . , 640bⱼ, 640m₁, . . . , 640mₖ in the Server event store 610.

The Server 606 keeps track of a list of pending events for each issue and client. Because issues are set up and recorded manually through the Web GUI by a technician, the system may generate an event before the technician has create an issue for it. For example, a Diagnostic Failure may be generated by a tester 620a and sent to the system 600 prior to the technician setting up an issue associated with the Diagnostic Failure event. In this case, this Diagnostic Failure event, like all unassigned events, are stored in a temporary “default issue” file 644a, 644b, 644m associated with the particular tester 620a, 620b, 620m until it can be reassigned by the technician/client. Events stored to a default issue file 644a, 644b, 644m are considered “pending”.

The Server 606 assigns a unique ID to each event that is successfully stored in the Server 606.

The Server 606 may include additional utilities that allow event tracking and reporting. For example, in one embodiment, a report generator 655 generates a summary XML file once per pre-determined interval (e.g., once per month) and stores the summary XML report on the server. Below is an example of a monthly report for an Agilent Versatest V5500 tester named “Thundercracker”:

Thundercracker.3-2006.xml
<?xml version=“1.0” standalone=“yes”?>
<!-- FILTERS USED
.name IN (v5x00)
.name IN (Thundercracker)
-->
<rtsreport timeStamp=“2006/03/29 13:22:52”>

<company name=“Agilent Technologies”>

<site name=“Santa Clara”>

<toolType name=“v5x00”>

<tool name=“Thundercracker” testCellSerial=“11111111”>

<event id=“932AF1B97F000001002DBFC16CDD1860”>

<type>Diagnostic Failure</type>
<created>2005/09/26 12:01:33</created>
<modified>2005/10/25 12:37:16</modified>
<automatic>true</automatic>
<description>sdsdsd</description>
<properties>

<property key=“Diagnostic Number”></property>
<property key=“Employee”></property>
<property key=“Failure Condition”></property>
<property key=“Failure Text”></property>
<property key=“Found During”>N/A</property>
<property key=“Notes”>this is a test</property>
<property key=“Part Number”></property>
<property key=“Repair Time”></property>
<property key=“Serial Number”></property>
<property key=“Software Revision”></property>

</properties>

</event>

</tool>

</toolType>

</site>

</company>

</rtsreport>

Through the Web GUI 608 the user can also access the server reporting utilities to run a report and output the results to an XML file.

In terms of event reporting capabilities on the data stored in the Server 606, one reporting feature of the Web GUI 608 may be a web page that lists all issues that are stored in a Server 606 that have not been closed (i.e., resolved). Another report may provide the user with an XML issue file that can be downloaded and opened using another application for processing.

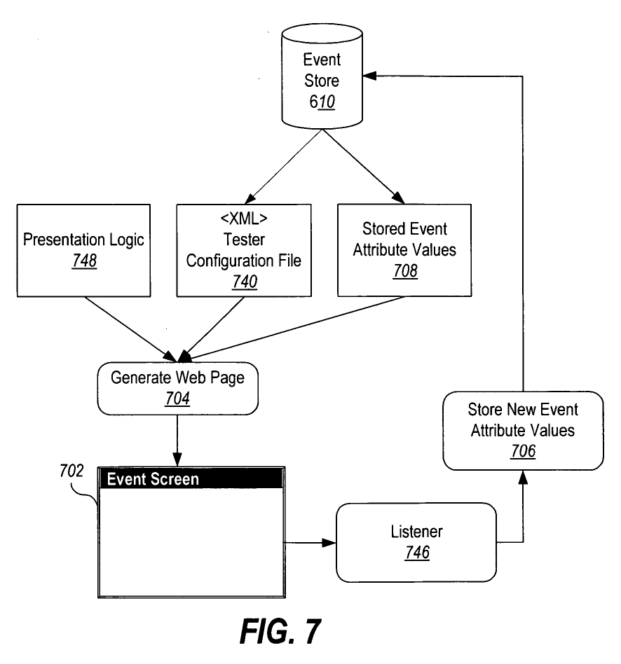

FIG. 7 illustrates the functional logic operation of an exemplary embodiment of the Web GUI 608. Presentation Logic 748 is implemented by the Web GUI 608 running on the Server 606 (FIG. 6). The Presentation Logic 748 includes a Web Page generator 704 which generates and presents an Event Screen 702 on a user's display. In doing so, the Presentation Logic 748 utilizes graphical presentation values associated with events from a selected tester as defined and stored in the Tester Configuration File 740 corresponding to the tester of interest to generate the graphics on the user's screen. The Presentation Logic 748 presents the stored event attribute values 708 stored in the event store 610 for events corresponding to the test cell of interest. The Event Screen 702 includes a mechanism to allow a user to store new event attribute values 706, for example using a listener 746 implemented in the Web GUI logic 608 on the server 606 (FIG. 6) which detects user input to store new event attribute values. The Web GUI logic stores 706 new event attribute values in the event store 610 upon user input of new event attribute values.

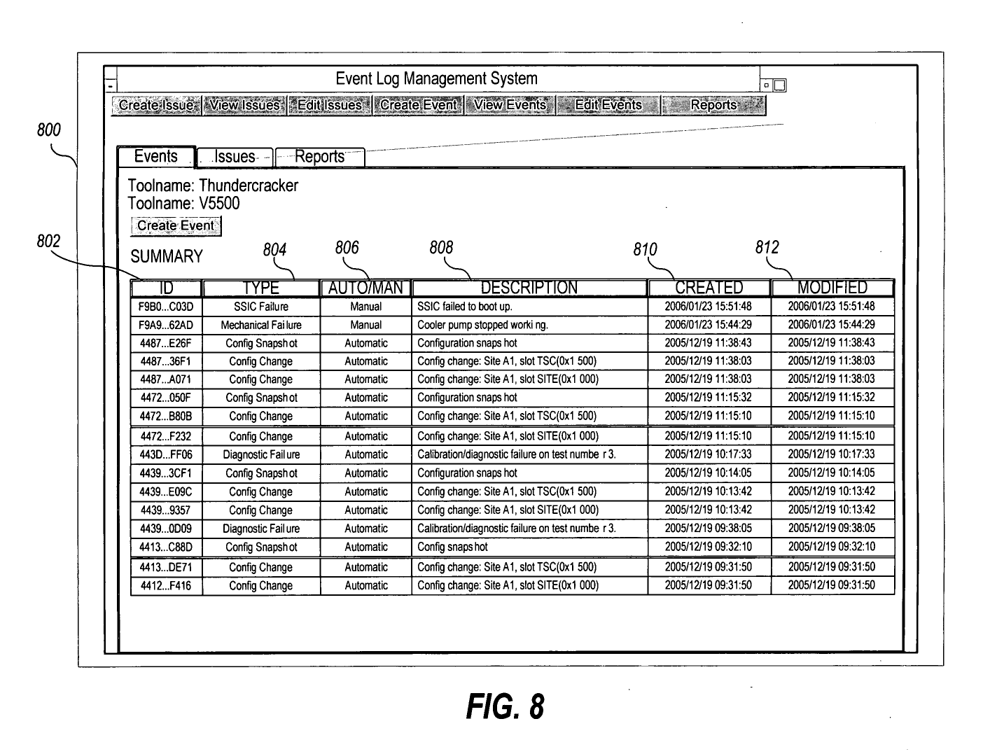

FIG. 8 illustrates an exemplary embodiment of an Event Summary Screen 800 presented by the Presentation Logic 748 (FIG. 7) of the Web GUI 608 of the Event Log Management Software. As shown, the Event Summary Screen 800 displays an event summary comprising a list of events for a particular tester. Although the events in the Event Summary Screen 800 are associated with a particular tester, it will be appreciated that an event summary could be presented displaying events associated with a given location (e.g., site, system, module, quadrant, sub-quadrant, etc.). In the exemplary embodiment shown in FIG. 8, the Events Summary Screen 800 displays the events in tabular form, including an event ID 802, the event type 804, whether the event was entered manually or automatically 806, a description of the event 808, the date/time of event creation 810, and date/time of the last modification to the event 812. Each event in the Events Summary Screen 800 is selectable to display details of the event.

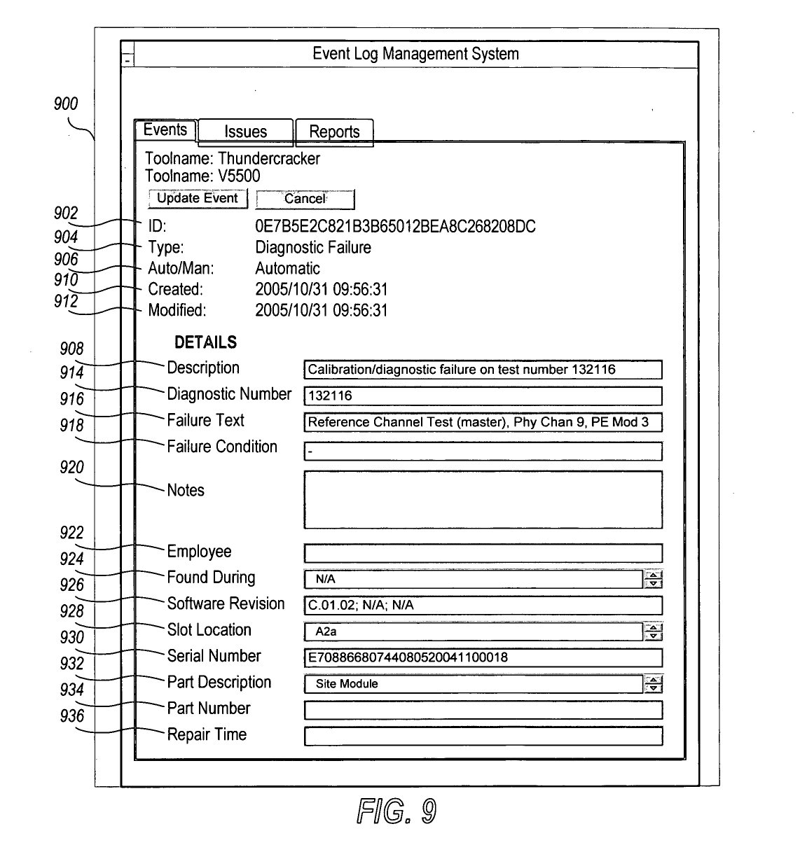

For example, FIG. 9 illustrates an exemplary embodiment of an Event Detail Screen 900 presented by the Presentation Logic 748 (FIG. 7) of the Web GUI 608 of the Event Log Management Software, illustrating the detail of an event selected from the Event Summary Screen 800. As shown, the selected event is of type “Diagnostic Failure”. As shown, the Event Detail Screen 900 displays the event information in detail, including an event ID 902, the event type 904, whether the event was entered manually or automatically 906, a description of the event 908, the date/time of event creation 910, and date/time of the last modification to the event 912. The event detail attributes associated with a Diagnostic Failure event type are also displayed in the Event Detail Screen 900, corresponding to the TestCell.xml configuration file from above. As illustrated, the Diagnostic Failure event attributes therefore displayed include the Diagnostic Number 914, the Failure Text 916, the Failure Condition 918, Notes 920, the Employee 922, a comboBox 924 entitled “Found During” with possible option values including “N/A”, “Installation”, “PM”, “Power Up”, “Probing”, “Troubleshooting”, “Retrofit”, “Engineering”, and “Automation improvements”, the Software Revision 926, a comboBox 928 entitled “Slot Location” with possible option values including “N/A”, “QA”, “QB”, “QC”, “QD”, “AC1”, “AC2”, “AC3”, etc., the Serial Number 930, a comboBox 932 entitled “Part Description” with option values including “AC Cal Board”, “AC/DC”, “ACPS/PDU”, “Auxiliary Power Supply”, “Backplane”, “Cables”, “CBB (Cable Buffer Board)”, etc., the Part Number 934, and the Repair Time 936.

The architecture of the Event Log Management System provides hardware independent automatic event capture, storage, and tracking, and a hardware independent GUI that allows user access with only a Web browser. Events are encapsulated in issues to allow symptoms (i.e., events) to be associated directly with the overall perception of what is happening (i.e., an issue), thereby displaying tracked events in a user-understandable format to assist the user in pinpointing and tracking sources of problems, areas of high activity, etc.

The innovative server architecture allows the addition, and modification, of any entry in the list of test cells, equipment, or modules monitored at any time during the life of the system. Not only can new entries be added by merely adding a corresponding configuration file to the server database, but also the attributes describing these entries can be variable since XML supports storing variable attribute lists.

Additionally, between the logic implementing the Web GUI runs on the system server and not on the client(s), an end user needs only to have access to a web browser and a network connection to access the Event Log Management System. By centralizing the GUI on the server, version control of the GUI is simple and universal, requiring version update only on the server and not at the individual user clients.

What is claimed is:

1. An Event Log Management System, comprising:
a data store which stores at least one tester configuration file;
a hardware independent event capture function which captures events from at least one monitored tester associated with one of the at least one test configuration files;
a graphical user interface which receives issue information from a user; and
a server which receives the issue information from the graphical user interface and creates an issue data element corresponding to the issue information, and which receives the captured events from the event capture function and stores the captured events in an event store, associating respective captured events with corresponding respective issues.

2. The system of claim 1, wherein the graphical user interface is web enabled.

3. The system of claim 1, wherein the hardware independent event capture function comprises a Web Services application program interface (API).

4. The system of claim 1, wherein the at least one tester configuration file is implemented in XML.

5. The system of claim 1, further comprising a reporting function which reports events associated with a particular one of the at least one testers.

6. The system of claim 1, further comprising a reporting function which reports events associated with a particular issue.

7. The system of claim 1, wherein the issue data element created by the server is implemented as an XML file.

8. The system of claim 7, wherein when the server receives a particular captured event from the event capture function, the server determines which particular issue, if any, of the issues the particular captured event is associated with, and stores the particular captured event in the XML file comprising the issue data element associated with the particular issue, and if the particular capture event is not associated with any issue, stores the particular captured event in an XML file comprising a default issue data element that is associated with a default issue.

9. A method for managing events of at least one tester, comprising:
obtaining at least one tester configuration file;
automatically capturing events from at least one monitored tester associated with one of the at least one test configuration files using a hardware independent interface;
receiving issue information; and
providing a server which creates an issue data element corresponding to the issue information, and which stores the captured events in an event store, and associates respective captured events with corresponding respective issues.

10. The method of claim 9, wherein the step of receiving issue information is performed through a web enabled graphical user interface.

11. The method of claim 9, wherein the step of automatically capturing events from at least one monitored tester comprises receiving events from the at least one monitored tester using a hardware independent event Web Services application program interface (API).

12. The method of claim 9, further comprising:
reporting events associated with a particular one of the at least one testers into a report, formatting the events in the report according to event attributes as defined in the tester configuration file associated with the particular one of the at least one testers.

13. The method of claim 9, further comprising a reporting function which reports events associated with a particular issue into a report, formatting the events in the report according to event attributes as defined in the tester configuration file associated with the particular one of the at least one testers.

14. The method of claim 13, wherein when the server receives a particular captured event from the event capture function, determines which particular issue, if any, of the issues the particular captured event is associated with, and stores the particular captured event in an XML issue file associated with the particular issue, and if the particular capture event is not associated with any issue, stores the particular captured event in an XML default issue file associated with a default issue.

15. An Event Log Management System, comprising:
a data store which stores at least one tester configuration file, each tester configuration file implemented in XML and comprising one or more event type definitions and corresponding attribute definitions;
a hardware independent event capture function which captures events from at least one monitored tester associated with one of the at least one test configuration files;
a Web enabled graphical user interface which receives issue information associated with a user perceived condition from a user; and
a server which creates an issue file implemented in XML corresponding to and encapsulating the issue information, and which encapsulates captured events captured by the hardware independent event capture function in respective issue files corresponding to respective issues to which the respective captured events are associated.

16. The system of claim 15, wherein the hardware independent event capture function comprises a Web Services application program interface (API).

17. The system of claim 15, further comprising a reporting function which reports events associated with a particular one of the at least one testers in an XML report file.

18. The system of claim 15, further comprising a reporting function which reports events associated with a particular issue in an XML report file.
